(19) United States
(12) Patent Application Publication
(10) Pub. No.: US 2023/0020494 A1
(43) Pub. Date: Jan. 19, 2023

(54) METHODS AND SYSTEMS OF AN AUTOMATED COLLABORATED CONTENT PLATFORM

(71) Applicants: Corey Sommers, SCOTTSDALE, AZ (US); Anil Kumar Jwalanna, SARATOGA, CA (US)

(72) Inventors: Corey Sommers, SCOTTSDALE, AZ (US); Anil Kumar Jwalanna, SARATOGA, CA (US)

(21) Appl. No.: 17/374,985

(22) Filed: Jul. 13, 2021

(51) Int. Cl. G06Q 10/10; G06N 5/04

(52) U.S. Cl. CPC G06Q 10/101; G06N 5/04

(57) ABSTRACT

A method for implementing a playbook factory with an automated collaborated content platform is provided.

### CLAIMS OF PRIORITY

This application claims priority to U.S. Provisional Application No. 63/023,872, filed on May 13, 2020. This provisional application is hereby incorporated by reference in its entirety.

### BACKGROUND

Improvements to automated collaborated content platforms are desired.

### BRIEF SUMMARY OF THE INVENTION

In one aspect, a method for implementing a playbook factory with an automated collaborated content platform is provided.

### BRIEF DESCRIPTION OF THE DRAWINGS

FIG. 1 illustrates an example process for implementing a playbook factory, according to some embodiments.

FIG. 2 illustrates an example process for framework for effective lead qualification factoring relevant elements and associated qualification criteria, according to some embodiments

FIG. 3 is a block diagram of a sample computing environment that can be utilized to implement various embodiments.

The Figures described above are a representative set and are not an exhaustive with respect to embodying the invention.

### DESCRIPTION

Disclosed are a system, method, and article of manufacture for an automated collaborated content platform. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment;’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application programming interface (API) can specify how software components of various systems interact with each other.

Big data is a field that treats ways to analyze, systematically extract information from, or otherwise deal with data sets that are too large or complex to be dealt with by traditional data-processing application software.

Cloud computing can involve deploying groups of remote servers and/or software networks that allow centralized data storage and elastic online access (meaning when demand is more, more resources will be deployed and vice versa) to computer services or resources. These groups of remote serves and/or software networks can be a collection of remote computing services.

Customer relationship management (CRM) is an approach to managing a company's interaction with current and potential customers. A CRM system can be a computing information systems marketing and management that helps automate various sales and sales force management functions. A CRM can include a marketing information system.

Data cleaning is the process of detecting and correcting (or removing) corrupt or inaccurate records from a record set, table, or database and refers to identifying incomplete, incorrect, inaccurate or irrelevant parts of the data and then replacing, modifying, or deleting the dirty or coarse data. Data cleansing may be performed interactively with data wrangling tools, or as batch processing through scripting.

Extract, transform, load (ETL) is the general procedure of copying data from one or more sources into a destination system which represents the data differently from the source(s) or in a different context than the source(s).

### Example Methods and Systems

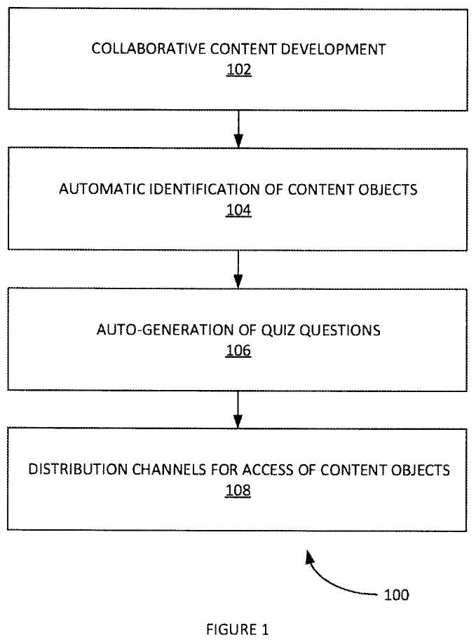

FIG. 1 illustrates an example process 100 for implementing a playbook factory, according to some embodiments. When a salesperson has conversations with customer, the salesperson can use process 100 to quickly find the needed content (e.g. uniform content) in the enterprises computing systems. The enterprise can be a corporate entity (e.g. an IoT sales company, etc.).

The uniform content can include enterprise approved talking points, differentiators, sales content, educational content, training content, etc. These can be pre-generated and reviewed by experts and/or other authority personnel within the enterprise.

Process 100 can use various graphical control elements to enable the salesperson (or other enterprise user) to access the uniform content. Example graphical control elements are provided in Appendix A. Appendix A also illustrates an example use case of process 100.

As shown, the uniform content can be selected and inserted into various digital/electronic communications formats by the user. For example, the uniform content can be pre-generated marketing content. The marketing content can be inserted into an email being drafted by the user. The user can modify the marketing content. The uniform content can be automatically formatted for the type of digital/electronic communications format currently being used by the user. For example, if the user has an email screen open and is composing an email, then the uniform content can automatically be rendered for insertion into an email format. It is noted that other digital/electronic communications formats (e.g. voice mail, text messages, digital video graphics, social network posts, blogs, PDF documents, etc.) can be used as well. Uniform content can be ‘bite-sized’ structured information that augment the conversations that enterprise employees have with outside persons and/or within the enterprise (e.g. during training sessions, etc.).

Process 100 can review content the user has already generated (e.g. content of an extant email, etc.); addressee of a current communication, user role in the enterprise, user search terms, etc. This information can be used to search for a set of relevant uniform content that the user can than select from. The user can also identify various graphical attributes of the uniform content (e.g. size, color, placement, logos, file types, etc.). In some examples, two or more uniform contents can be integrated into an electronic communication so that the user can have an effective conversation. Process 100 can automatically modify the two or more uniform contents in order to merge them in a seamless manner.

Users can also group uniform content by personas such that best information can be used with the addressee. For example, the industry of the addressee can be taken into account when using uniform content. The uniform content can be provided to a playbook framework (e.g. see Appendix A). The playbook framework can be organized based on various use cases the occur within the enterprise. As shown, these use cases can be access via the tabs. The tabs can lead to various uniform content(s) that are stored in a content inventory. Tabs can be expanded to show uniform content headers. Headers can be accessed to access the blocks of uniform content. Key points can be listed as well for ease of review and selection of the most relevant uniform content. Process 100 automatically synthesize selected and other relevant uniform content. Process 100 can help build the structure of the uniform content in a grouped manner. Uniform content can be synthesized by source (e.g. from whom was the content collected).

The uniform content can be stored in a database. Various search tags and/or other metadata can be used to make the uniform content quickly searchable. Users can query the database of uniform content with questions. The source information can be stored with the uniform content.

It is noted that uniform content can be captured from various sources within the enterprise. For example, an elevator pitch can be decomposed into various content blocks that can be populated with uniform content. Process 100 can review the content inventory and remove redundant content (e.g. duplicate content, dated content, etc.).

The tool can be collaboration tool. Various other users within the enterprise can vote on the quality of the uniform content. In this way, uniform content can be ranked (e.g. by highest votes and/or other metrics). Higher ranked content can be placed higher in the content selection when a user accesses an associated tab.

Multiple users can collaborate with each other to select and edit uniform content as well. This can be done using a spread sheet-type program. Content can be ingested from different documents and/or other sources. For example, a web browser plug in can be used to obtain white papers and/or other content (e.g. highlighted content on a blog) for dynamically pulling uniform content into the content database. This pulled-in uniform content can also be edited and updated by the user as well.

More specifically, in step 102 process 100 can implement implementing a playbook factory collaborative content development. Collaborative content development can include, inter alia: voting on uniform content quality, adding uniform content, updating uniform content, etc. For example, process 100 can present a user with existing content objects and allow the user to vote on the accuracy/value of the objects in the uniform content. In another example, process 100 can present a user with existing uniform content objects and enable the user to add additional content objects in a side-by-side view (e.g. see the various screen shots provided in the Appendices, etc.). Collaborative content development can include task assignment. For example, process 100 can assign a user with content development tasks for a specific object/topic of content and allow them to view existing/related content as they contribute. It is noted that specific uniform content objects in our model can include, inter alia: Value messages; differentiators; questions to ask; objects and how to respond; anxiety questions; ideal customer profile; customer challenges; win stories and case studies; etc.

In step 104, process 100 can implement automatic identification of content objects from source documents and websites; etc. Process 100 can define sets of keywords, phrases, grammar (e.g. taxonomies) for each element of playbook content. Process 100 can search source documents for matching content (e.g. provide detailed doc on taxonomy structure). Process 100 can ingest matching data and auto-generate ‘candidate’ content blocks for approval/editing by users. Use AI and ML to break down documents into individual key points/blocks based on specified dimensions and attributes and then present in the interface tool utilizing process 100. Various collaborators can be assigned editing/updating tasks to create the uniform content. In this way, the uniform content can be created, synthesized, reviewed and published to end users. The playbook can be printed and provided to end users. Process 100 can also generate a navigable playbook that can be accessed to integrate uniform content into digital communications (e.g. drag and dropped into an email using a web browser widget, etc.).

In step 106, process 100 can implement auto-generation of quiz questions based on playbook content. For example, for any given set of content, process 100 can auto-generate quiz questions for inclusion in email/web quiz for measuring playbook adoption.

It is noted that the systems that implement the processes provided supra can be embedded with a CRM system. Users can quickly find tags and content they are looking for to integrate into communications and/or answer client questions. The content can be dynamic listed based on information/queries provided by users. Attribute values can be automatically read and filtered.

The system implementing process 100 can digest content from multiple sources, including voice content captured during sales/business conversations; pdfs from business content. AI and ML can be used to classify, cluster and synthesize the ingested content. Collaborative filtering/updating can also be implemented on the content before it is published (e.g. as a pdf playbook, web browser widget for drag and drop operations, smart phone applications, Alexa application, etc.). In step 108, process 100 can implement distribution channels for access of content objects.

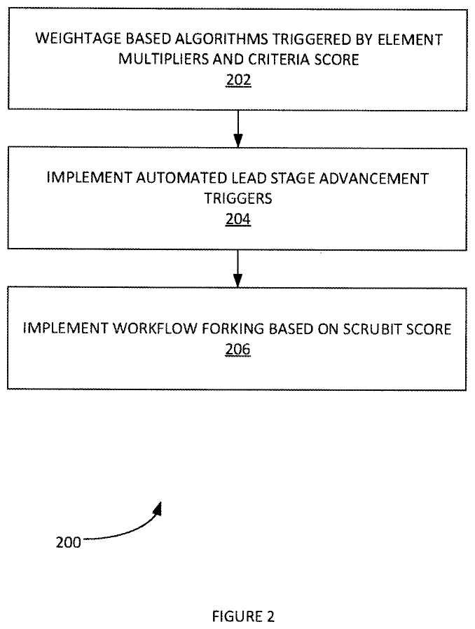

FIG. 2 illustrates an example process 200 for framework for effective lead qualification factoring relevant elements and associated qualification criteria, according to some embodiments. It step 202, process 200 can implement a framework (e.g. a SCRUBIT Framework, etc.) for effective lead qualification factoring relevant elements and associated qualification criteria. In step 204, process 200 can implement weightage-based algorithms triggered by element multipliers and criteria score (e.g. a score relevant to a Sales Motion metric). This can include automated lead stage advancement triggers. In step 206, process 200 can implement a workflow forking. The workflow forking can be based on the previously determined score (e.g. the SCRUBIT score). It is noted that various AI and/or ML based algorithms to automate SCRUBIT scoring of a lead (e.g. see the discussion of ML infra). Additionally, the AI and ML based algorithms can be used to assess and correlate Salesperson's accuracy of SCRUBIT scoring. Additionally, process 200 can use data voice capture of sales conversations and voice analytics using the AI and/or ML to generate meeting summary and insights (e.g. using an Alexa system, etc.). Furthermore, process 200 can use benchmarks and leaderboards. Additional information for implementing process 200 is provided in Appendix B.

Appendix C illustrates an example automated on-boarding system. It is noted that a sales on-boarding framework is shown that can train salespeople during the first 90 days on their tenure with an enterprise. As shown in the screen shots, a structured workflow, set of activities and task management is provided. This can take the form of a training boot camp for the first 30 days, 60 days and 90 days of tenure. The automated on-boarding system can also provide an assessment and scorecard for each element of 9-in-90 based on the salesperson's knowledge, skills and process understanding. This can be modified and aligned with various industry frameworks. The automated on-boarding system can utilize a benchmarking and leaderboard as well.

Appendix D illustrates an example implementation of a sales forecast platform. The sales forecast platform can provide business, technical and legal (BTL) assessments of an opportunity at every stage of the sales process. The sales forecast platform can provide a framework with assessment criteria to classify each element of BTL into ‘Enableocity Gates’. These can be in a ranking format such as: HIGH, GUT and LOW. AI and ML based algorithms can be used to auto classify opportunities for accurate forecasting using the sales forecast platform and Enableocity gates.

### Example Machine Learning Implementations

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning. Random forests (RF) (e.g. random decision forests) are an ensemble learning method for classification, regression and other tasks, that operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, that is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. This procedure is complicated in practice by the fact that the validation dataset's error may fluctuate during training, producing multiple local minima. This complication has led to the creation of many ad-hoc rules for deciding when overfitting has truly begun. Finally, the test dataset is a dataset used to provide an unbiased evaluation of a final model fit on the training dataset. If the data in the test dataset has never been used in training (e.g. in cross-validation), the test dataset is also called a holdout dataset.

### Additional Example Computer Architecture and Systems

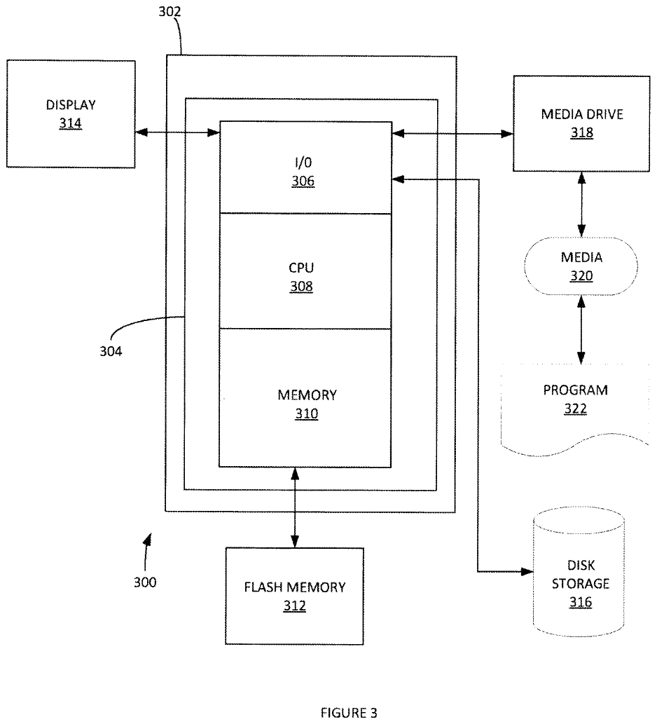

FIG. 3 depicts an exemplary computing system 300 that can be configured to perform any one of the processes provided herein. In this context, computing system 300 may include, for example, a processor, memory, storage, and I/O devices (e.g., monitor, keyboard, disk drive, Internet connection, etc.). However, computing system 300 may include circuitry or other specialized hardware for carrying out some or all aspects of the processes. In some operational settings, computing system 300 may be configured as a system that includes one or more units, each of which is configured to carry out some aspects of the processes either in software, hardware, or some combination thereof.

FIG. 3 depicts computing system 300 with a number of components that may be used to perform any of the processes described herein. The main system 302 includes a motherboard 304 having an I/O section 306, one or more central processing units (CPU) 308, and a memory section 310, which may have a flash memory card 312 related to it. The I/O section 306 can be connected to a display 314, a keyboard and/or other user input (not shown), a disk storage unit 316, and a media drive unit 318. The media drive unit 318 can read/write a computer-readable medium 320, which can contain programs 322 and/or data. Computing system 300 can include a web browser. Moreover, it is noted that computing system 300 can be configured to include additional systems in order to fulfill various functionalities. Computing system 300 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### Example Machine Learning Implementations

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning. Random forests (RF) (e.g. random decision forests) are an ensemble learning method for classification, regression and other tasks, that operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, that is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. This procedure is complicated in practice by the fact that the validation dataset's error may fluctuate during training, producing multiple local minima. This complication has led to the creation of many ad-hoc rules for deciding when overfitting has truly begun. Finally, the test dataset is a dataset used to provide an unbiased evaluation of a final model fit on the training dataset. If the data in the test dataset has never been used in training (for example in cross-validation), the test dataset is also called a holdout dataset.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

1. A method for implementing a playbook factory with an automated collaborated content platform is claimed.
